(19) United States
(12) Patent Application Publication
(10) Pub. No.: US 2003/0105417 A1
(43) Pub. Date: Jun. 5, 2003

(54) Pain away

(76) Inventor: Thomas Alexander Drake, Rancho De Taos, NM (US)

Correspondence Address: Thomas Alexander Dranke, 1681 Hause, Quinlan, TX, 75474, US

(21) Appl. No.: 09/999,448

(22) Filed: Dec. 3, 2001

(51) Int. Cl. A61H 15/00; A61H 23/00

(52) U.S. Cl. 601/70; 601/73; 601/120; 601/121

(57) ABSTRACT

PAIN AWAY consists of two handgrips (F) on either side of a treatment core (R). This treatment core (R) has a pair of permanent belts (L) mounted on wheels (C) for pressure treatment of the muscles beside the spine, to relieve back pain and produce relaxation. A detachable belt (M) is used for cellulite treatment. The device vibrates as desired. Since this is the first device based on the acupressure method of back pain relief it is unique in concept.

Drake's search of existing patents as provided by the PTDL in Dallas, Tex. #606/204 revealed nothing like PAIN AWAY. Specific features that make it unique are: (1) the fact that it rolls up and down the back; and other parts of the body, eliminating the use of creams or abrasive rubbing motions; (2) the pyramids on the belts need not ever touch the skin itself thereby lessening the chance of transmittal of any infections from one person to another (if the device is used in a commercial manner such as hospital therapy); (3) the fact that the spinal gap spacer (and vibrator housing) (B) makes it ideal for the treatment of spinal pain associated with muscle tension; (4) the fact that the pyramids (S) on the belts (L, M) are rubber will prevent injury: (5) the fact that the simplicity of the use of PAIN AWAY makes it easy for a non-professional to use easily: (6) the fact that it is a cellulite treatment method that does not require lotions and cremes.

### NO RELATED APPLICATIONS HAVE BEEN FOUND.

### NO FEDERALLY SPONSORED RESEARCH AND DEVELOPMENT IS REQUESTED

### THIS IS A NON-PROVISIONAL APPLICATION FOR A PATENT ON A DEVICE CALLED PAIN AWAY.

### BACKGROUND OF THE INVENTION

Thomas A. Drake, the inventor, has a history of chronic back pain following two back surgeries for fractured discs. At one time a doctor certified Drake as totally disabled due to his bad back. Drake was introduced to the back pain relief technique acupressure, which afforded him some relief but was painful to the hands of his volunteer therapists. Drake invented the device PAIN AWAY and reduced it to practice to deal with his own back pain. In researching other patents, provided by the PTDL in Dallas, Tex., Re: 606/204, Drake could find nothing similar to his device.

### BRIEF SUMMARY OF TIE INVENTION

The device consists of two handgrips (F) on either side of a treatment core (R). The treatment core (R) consists of two small wheels (C) covered by permanently mounted rubber belts (L) with a spinal gap spacer and vibrator housing (B) between them. Each belt (L) is studded with soft rubber pyramids (S). The pyramids (S) are approximately ⅝ inch high and approximately ¾ inch apart at the top. The belts (L) are the width of the wheels (C). There is a one-inch gap between the wheels (C) for the spine of the person being treated. PAIN AWAY is used on a facedown prone positioned person by another person sitting astride or leaning over him. The person facilitating grasps PAIN AWAY by the handgrips (F) and rolls the device up and down the spine of the prone person. Although the rubber pyramids (S) are soft enough to prevent spinal injury, care should be taken to position the spinal gap spacer over the spine of the person being treated for maximum therapeutic benefit. As referred to in claim One of this document, treatment as described promotes pain relief and relaxation. PAIN AWAY comes with a secondary belt (M), which eliminates the spinal gap space between the two wheels and is used to aid in the reduction of cellulite, (fatty tissue deposits), as referred to in claim Two of this document.

### THE DRAWINGS

Drawings were prepared and submitted in actual size (except as noted). The ⅔rds reduction made in publishing the views would therefore produce a scale of 0.6667″=1″.

The Views:

FIG. 1 depicts the overall appearance of the device and differentiates between the handgrips (F) and the treatment core (R). FIG. 1 is on pages 1 and 2.

FIG. 2 shows how the two parts of FIG. 1 join together. FIG. 2 is on page 2.

FIG. 3 is a cross-section front view of the device showing all parts and materials. FIG. 3 is on pages 3 and 4.

FIG. 4 shows how the two parts of FIG. 3 join together. FIG. 4 is on page 4.

FIG. 5 shows the cellulite belt (M), the spinal gap spacer and vibrator housing (B) and the Velcro strips (N) that attach them together when this belt is in use.

FIG. 6 is a cross-section side view showing the vibration device weight and pulley mounted on the hollow metal axle inside the spinal gap spacer and vibrator housing.

FIG. 7 is an angular view of one of the permanent belts showing one of the pyramids.

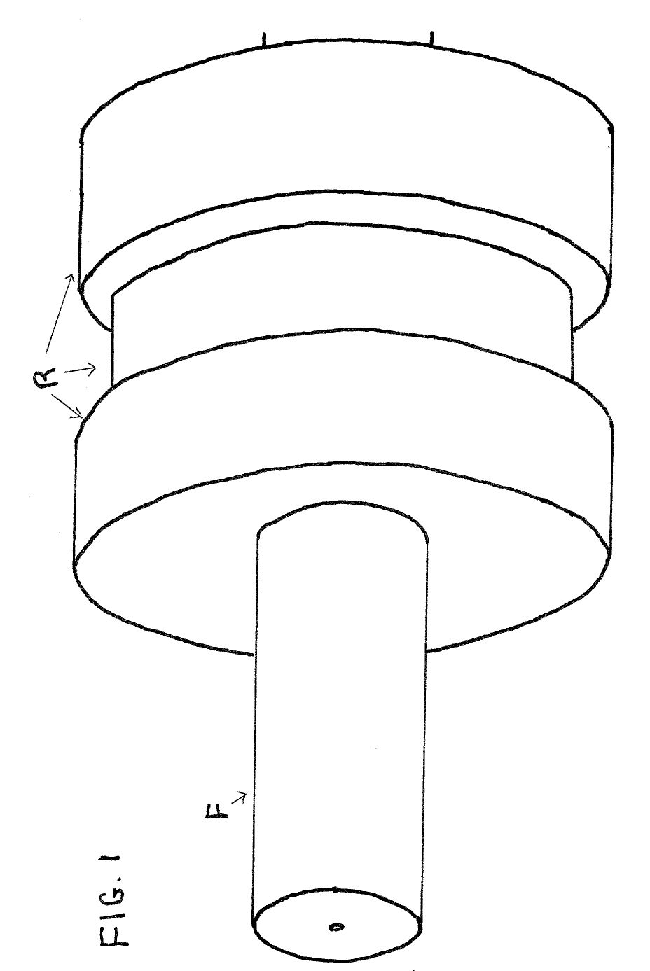

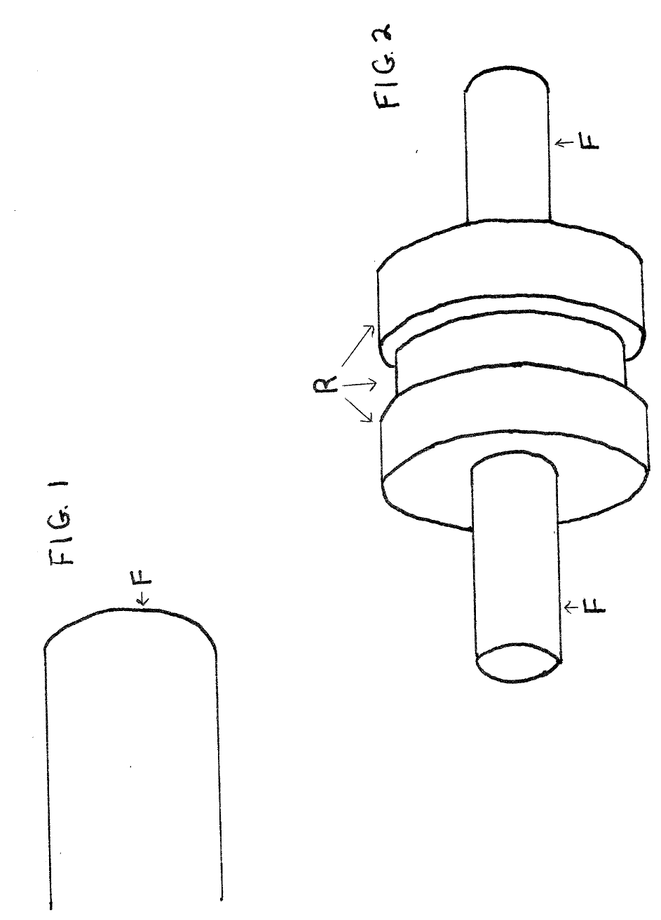

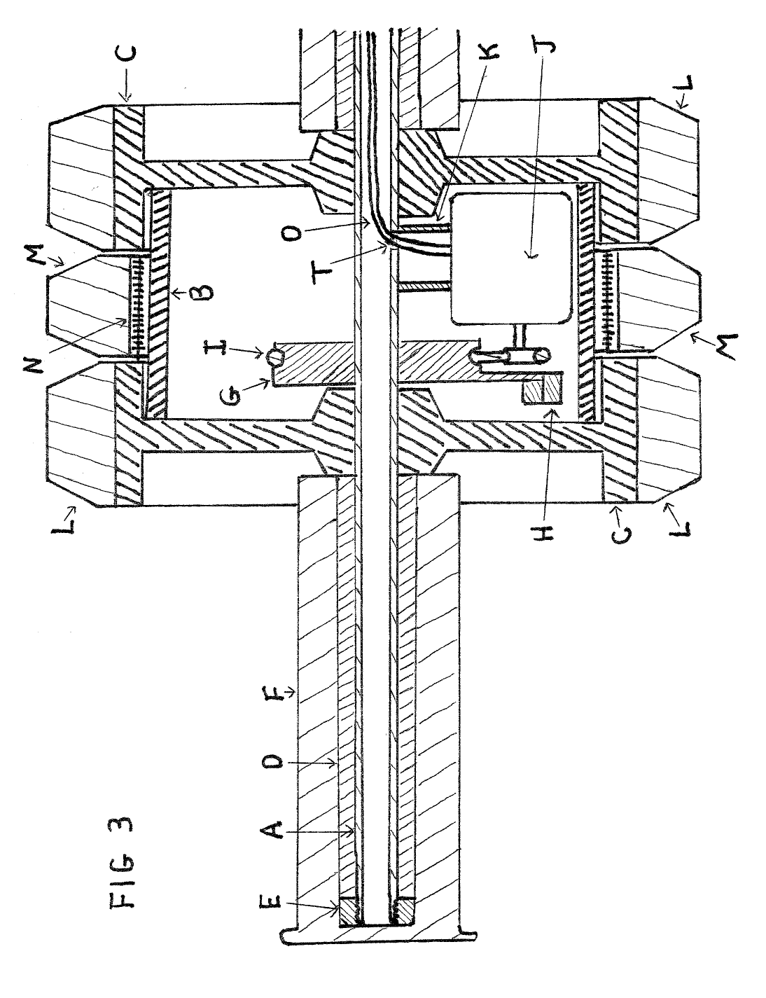

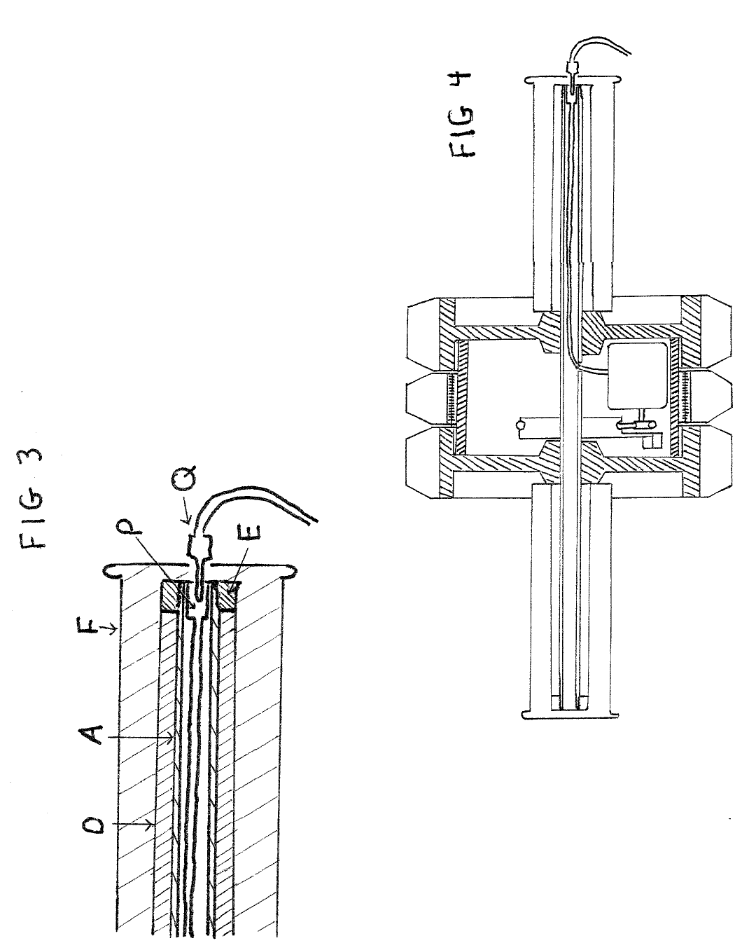

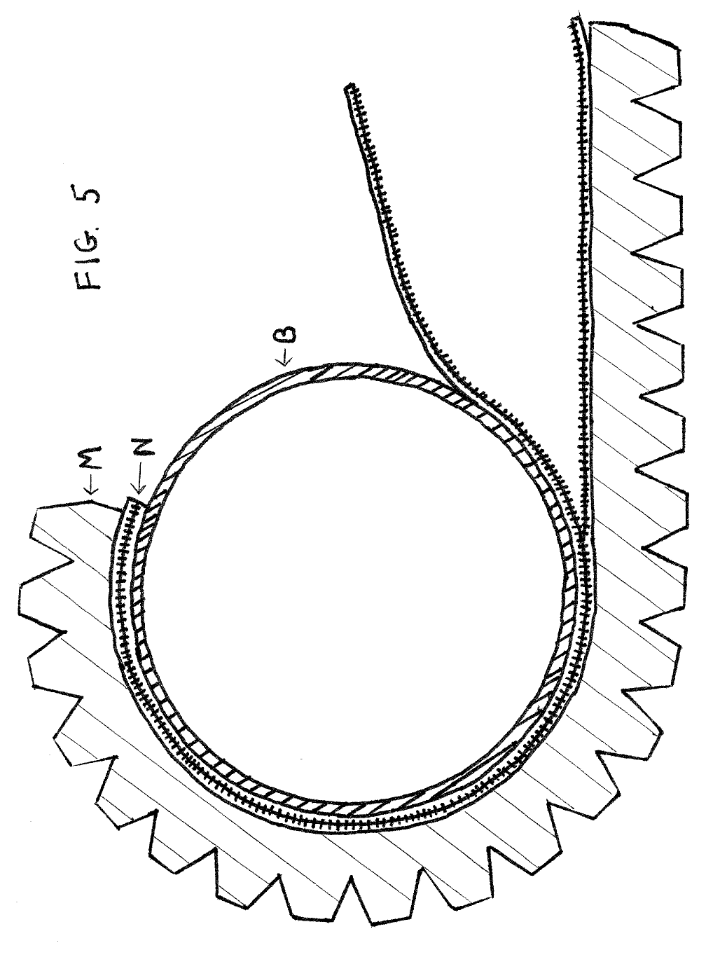

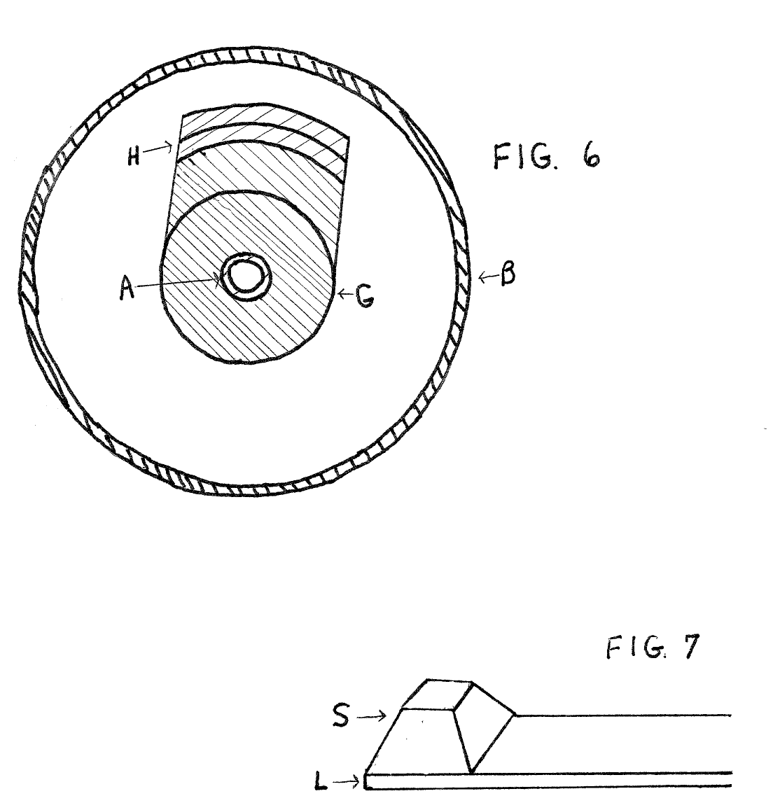

The Reference Characters:

A. Hollow metal axle with threaded ends.

B. Hard plastic spinal gap spacer and vibrator gap housing.

C. Hard plastic wheels.

D. Hard plastic bushing.

E. Metal hex nut.

F. Plastic handgrip.

G. Hard plastic vibration device pulley.

H. Metal vibration device weight.

I. Rubber vibration device pulley belt.

J. Vibration device electric motor (miscellaneous materials).

K. Metal vibration device motor mounts.

L. Rubber permanent belts.

M. Rubber cellulite belt.

N. Velcro (hook and loop).

O. Electrical wire.

P. Female electrical receptacle.

Q. Male electrical end.

R. Treatment core.

S. Rubber pyramids (on belts).

T. Electrical cord access hole.

### DETAILED DESCRIPTION

PAIN AWAY consists of two cylindrical handgrips (F) similar to bicycle handlebar grips on either side of the treatment core (R). Inside each handgrip (F) at the outside edge of the handgrip (F) is a permanently mounted hex nut (E). A plastic bushing (D) is permanently mounted inside each handgrip (F) between the hex nut (E) and the treatment core (R). A hollow metal axle with threaded ends (A) runs through the treatment core (R). This hollow metal axle (A) screws into the hex nuts (E) inside the handgrip ends (F) to hold the device together. One end of the hollow metal axle (A) contains a female plug-in receptacle (P) for the electrical supply. On this end there is an access hole for the male end (Q) of the extension cord. The treatment core (R) sits between the handgrips (F). It consists of two plastic wheels (C) similar to those used on lawn mowers separated by a heavy plastic housing (B) that acts as spinal gap spacer and vibrator housing (B). Each wheel (C) is covered by a permanently mounted belt (L). These belts (L) are studded with soft rubber pyramids (S) approximately ⅝ inch high. Due to their pyramidal form, there is a gap between them of approximately ¾ inch at the top and they are approximately ⅜ inch by ⅜-inch square on the top plane. They approximate the position of thumbs on the muscle pairs that bracket the spine; this positioning is integral to the acupressure back pain treatment method.

The cellulite belt (M) attaches to spinal gap spacer and vibrator housing (B). There is a permanently mounted Velcro strip (N) (loop) on the spinal gap spacer and vibrator housing (B). On the back of the cellulite belt (M) there is a permanently mounted Velcro strip (A) (hook). The cellulite belt (M) is similar to the permanently mounted belts (L) on the two wheels (C), however the base of this belt (M) is approximately ¼ inch thicker so that when the cellulite belt (M) is in place three rows of level pyramids (S) are on the device and there is no longer a spinal gap space. The use of Velcro (N) permits easy installation and removal of this belt.

### Construction

With the exception of the belts (L, M) every part of this invention can be assembled from commonly available parts. The belts, being rubber, will be molded. Assembly proceeds as follows. The Velcro strips (N) on the spinal gap spacer and vibrator housing (B) and the cellulite belt (M) are permanently mounted. The permanent rubber belts (L) are permanently mounted on the wheels (C). A hole (T) is drilled near the center of the hollow metal axle (A); and the wire (O), which is attached to the female receptacle (P), is threaded through until the female receptacle (P) is in place. Then the vibration device weight (H) is affixed to the vibration device pulley (G) and the vibration device motor (J) is affixed to the vibration device motor mount (K). Then the vibration device motor (J) and vibration device pulley (G) are centrally mounted on the hollow metal axle (A) and the electrical wire (O) is attached to the vibration device motor (J). The pulley belt (@) is then attached to the vibration device motor (J) and the vibration device pulley (G). Next, the spinal gap spacer and vibrator housing (B) is placed around the vibration device pulley (G) and motor (J) which are on the hollow metal axle (A). The two wheels (C) are mounted on the hollow metal axle (A) on either side of the spinal gap spacer and vibrator housing (B). Then the hex nuts (E) and bushings (D) are mounted inside the handgrips (F). The handgrips (F) are mounted on either end of the hollow metal axle (A). The hollow metal axle (A) is permanently affixed into the handgrip (F) on the end that houses the female receptacle (P). The other handgrip (F) is screwed onto the hollow metal axle (A) to complete the device.

### Use

In the back treatment mode, PAIN AWAY uses a rolling action and pressure and vibration (if desired) to soothe muscle tension. One person lies prone in a face down position; another person carefully positions the spinal gap spacer over his spine and rolls PAIN AWAY up and down his spinal column putting pressure on the muscles on either side of the spine.

In the cellulite treatment mode, PAIN AWAY can be used by one person who rolls the vibrating device over areas of cellulite with as much pressure as desired.

### Mode of Carrying out Invention

It is Drake's intention to create molds for the rubber belts (L, M) and contract with a manufacturer for their production. Drake intends to order all other parts from their manufacturers and set up a small assembly operation, expanding as orders demand.

1. Pain away reduces back pain using the basic principles of the acupressure method of pain treatment: In acupressure, the therapist places his/her thumbs on the two muscles on either side of each vertebra and applies heavy pressure. Approximately 7 seconds of this pressure causes the muscles to relax removing pressure from the vertebra. The therapist goes down the spinal column causing each pair of muscles to relax. Since chronic pain is usually associated with muscle tension, the result of acupressure is pain relief. PAIN AWAY mimics the action of acupressure by putting pressure on the muscle pairs on geach side of the spine simultaneously. Because it works on the whole spine at once, it provides superior pain relief to that provided by acupressure. PAIN AWAY is effective in the hands of a non-therapist. Drake built a prototype and used it to treat his own back pain. The relief exceeded that from acupressure treatment and eliminated Drake's need for pain medication. Testing on others relaxed them into sleep. PAIN AWAY can also be used on the neck to provide relief from headaches caused by tension. PAIN AWAY promotes relaxation, thereby being an aid to insomnia. The vibrating mode, which is optional, enhances the effects of this device.

2. PAIN AWAY is useful in breaking down the hard fatty deposits known as cellulite because the pressure of the vibrating pyramids on the cellulite areas will break individual cells and cause the body to absorb them.
